(19) United States
(12) Patent Application Publication
(10) Pub. No.: US 2011/0126502 A1
(43) Pub. Date: Jun. 2, 2011

(54) DRIVING SPEED CONTROL FOR POWER EQUIPMENT

(75) Inventors: Richard J. Pitman, Nashville, TN (US); Paul T. Wallace, Lewisburg, TN (US)

(73) Assignee: Briggs & Stratton Corporation

(21) Appl. No.: 12/627,877

(22) Filed: Nov. 30, 2009

(51) Int. Cl. A01D 69/00; A01D 34/00

(52) U.S. Cl. 56/10.8; 56/11.3

(57) ABSTRACT

Power equipment is designed to be operated by a user walking behind the power equipment, and includes an engine, a body, a drivetrain, a handle, a linkage, and a mechanism. The engine drives a working implement. The drivetrain links the engine to at least one wheel designed to drive the power equipment. The handle extends from the body, where at least a portion of the handle is designed to rotate relative to the body. Rotation of the at least a portion of the handle relative to the body is communicated to the drivetrain via the linkage, and controls a driving speed of the power equipment. The mechanism is designed to provide a mechanical advantage between rotation of the handle and operation of the linkage.

### BACKGROUND

The present disclosure relates generally to the field of power equipment driven by small combustion engines. More specifically the present disclosure relates to walk-behind, self-propelled, outdoor power equipment, such as a rotary lawn mower, a snow thrower, a tiller, and the like.

Power equipment, such as rotary lawn mowers, snow throwers, a tillers, and the like, may be self-propelled. A user walks behind, controlling the power equipment via a rearwardly extending handle. The power equipment is typically driven by a small engine, such as a one-, two-, or three-cylinder, gasoline-powered, two- or four-stroke cycle, internal combustion engine. The engine drives the working implement of the power equipment, and is also coupled to the drivetrain. Such a drivetrain may include a transmission, a clutch, a drive shaft, an axle, and other components used to transfer engine power to wheels of the power equipment. The user may control the driving speed of the power equipment by adjusting a control lever typically positioned on the handle.

### SUMMARY

One embodiment of the invention relates to power equipment designed to be operated by a user walking behind the power equipment. The power equipment includes an engine, a body, a drivetrain, a handle, a linkage, and a mechanism. The engine drives a working implement. The drivetrain links the engine to at least one wheel designed to drive the power equipment. The handle extends from the body, where at least a portion of the handle is designed to rotate relative to the body. Rotation of the at least a portion of the handle relative to the body is communicated to the drivetrain via the linkage, and controls a driving speed of the power equipment. The mechanism is designed to provide a mechanical advantage between rotation of the handle and operation of the linkage.

Another embodiment of the invention relates to power equipment designed to be operated by a user walking behind the power equipment. The power equipment includes a combustion engine, a body, a drivetrain, a handle, and a linkage. The combustion engine drives a working implement. The drivetrain links the engine to at least one wheel. The handle extends from the body, and includes an upper portion, a lower portion, a first pivot, and a second pivot. At least one of the portions of the handle is designed to rotate relative to the body about the first pivot. The second pivot links the upper portion and the lower portion, and is designed to allow the upper portion to be rotated into a storage configuration, such that the longitudinal length of the power equipment is reduced. Rotation of the at least one of the portions of the handle relative to the body is communicated to the drivetrain via the linkage, and controls a driving speed of the power equipment.

Yet another embodiment of the invention relates to a self-propelled, walk-behind, rotary lawn mower. The lawn mower includes a combustion engine, a body, a drivetrain, a handle, a linkage, and a mechanism. The combustion engine drives a lawn mower blade. The drivetrain links the engine to at least one wheel. The handle extends rearward from the body, and includes an upper portion, a lower portion, a first pivot, and a second pivot. At least one of the portions of the handle is designed to rotate relative to the body about the first pivot. The second pivot links the upper portion and the lower portion, and is designed to allow the upper portion to be rotated into a storage configuration, such that the longitudinal length of the lawn mower is reduced. Rotation of the at least one of the portions of the handle about the first pivot is communicated to the drivetrain via the linkage, and controls a driving speed of the at least one wheel. The mechanism includes at least one of a pulley, a gear, a belt, and a chain, and is designed to provide a mechanical advantage between rotation of the at least one of the portions of the handle about the first pivot and operation of the linkage on the drivetrain.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a lawn mower according to an exemplary embodiment of the invention.

FIG. 2 is a perspective view of a lawn mower shown in a first configuration according to an exemplary embodiment of the invention.

FIG. 3 is a perspective view of the lawn mower of FIG. 2 shown in a second configuration.

FIG. 4 is a perspective view of the lawn mower of FIG. 2 shown in a third configuration.

FIG. 5 is a first exploded view of a portion of the lawn mower of FIG. 2.

FIG. 6 is a second exploded view of a portion of the lawn mower of FIG. 2.

FIG. 7 is a side view of a lawn mower according to an exemplary embodiment of the invention.

FIG. 8 is a perspective view of a handle for a lawn mower according to another exemplary embodiment of the invention.

FIG. 9 is a side view of a portion of the handle of FIG. 8.

FIG. 10 is a perspective view of a handle for a lawn mower according to yet another exemplary embodiment of the invention.

FIG. 11 is a perspective view of the lawn mower of FIG. 10.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

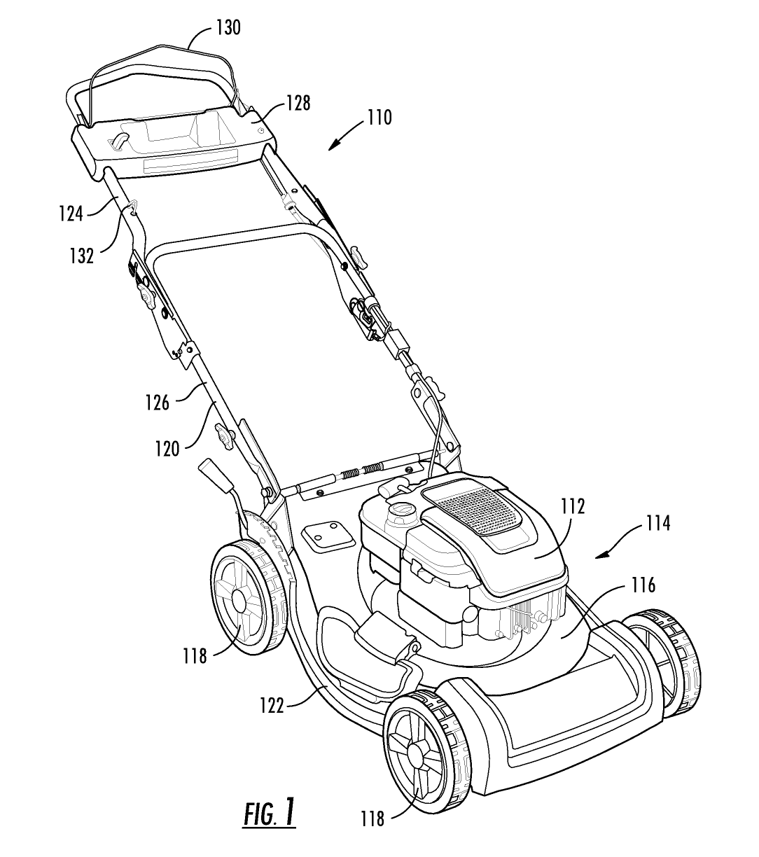

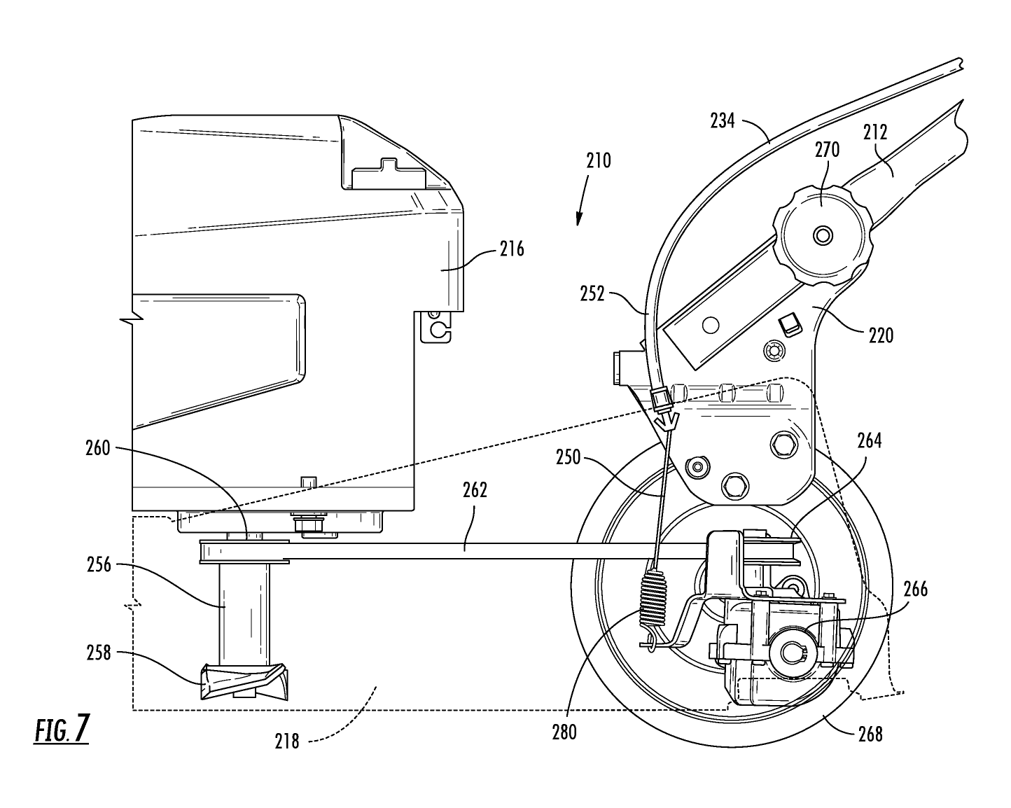

Referring to FIG. 1, power equipment is shown in the form of a lawn mower 110. More specifically, the lawn mower 110 is a self-propelled, walk-behind, rotary lawn mower that is driven by an engine 112. The lawn mower 110 includes a body 114 having a mowing deck 116, the engine 112, and wheels 118. A handle 120 extends rearward from the body 114. The body 114 further includes a skirt 122 surrounding a working implement in the form of a lawn mower blade (see, e.g., blade 258 as shown in FIG. 7). During operation of the lawn mower 110, the engine 112 rotates the blade to cut grass. Additionally, the lawn mower 110 includes a drive system (see generally FIG. 7) in which power from a crankshaft or power take-off (see, e.g., power take-off 256 as shown in FIG. 7) of the engine 112 is controllably transferred to the wheels 118 via a drivetrain (e.g., drive system, drive-related components, etc.).

The handle 120 of the lawn mower 110 includes several components, such as an upper portion 124 (e.g., upper handle), a lower portion 126, a control panel 128, a lever 130, and a rope guide 132 for a pull cord of a recoil starter of the engine 112. During operation of the lawn mower 110, the user walks behind the lawn mower 110 and holds the upper portion 124 of the handle 120. The lever 130 serves as a dead man's switch (i.e., fail safe) that is biased toward an off-position, and is manually held in an on-position to permit the lawn mower 110 to operate. While cutting grass, operation and features of the lawn mower 110 may be adjusted, engaged, disengaged, etc. by the user via features associated with the handle 120. For example, the control panel 128 may include a throttle lever for adjusting the engine speed (e.g., rotations per minute). A user of the lawn mower 110, may also control the driving speed of the lawn mower 110 by rotating the handle 120 forward or backward relative to the body 114.

According to an exemplary embodiment, the handle 120 is formed from a network of tubular members. As shown in FIG. 1, the tubular members of the handle 120 are bolted together, but in other embodiments, the tubular members may be welded, glued, pinned, integrally formed, or otherwise coupled. The handle 120 may be formed from metal tubes (e.g., steel, aluminum, etc.), composite, or other materials. In other embodiments, a handle of the lawn mower 110 or other power equipment is formed from solid beams, U-beams, I-beams, a flat rectangular plate that extends rearward from the body 114, or other structures.

While FIG. 1 shows power equipment in the form of the lawn mower 110, the disclosure provided herein may be used with a broad range of power equipment. For example, the handle 120, the engine 112, and the drivetrain (see FIG. 7) of the lawn mower 110 may be used with many types of walk-behind power equipment. Some embodiments include a one- or two-stage snow thrower, a powered tiller (e.g., cultivator, roto-tiller, etc.), a cement cutter, a leaf blower, and other types of power equipment. Accordingly, the engine 112 may be used to drive a broad range of working implements, such as the lawn mower blade (see FIG. 7), an auger for a snow thrower, an auger for a tiller, a saw, a sport field-line paint sprayer, a fan, and other working implements employed by power equipment. Furthermore, while the lawn mower 110 of FIG. 1 includes the engine 112, other embodiments may use an electric motor, a pneumatic motor, or another form of prime mover that powers the drivetrain. The prime mover powering the working implement may be different from the prime mover powering the drivetrain.

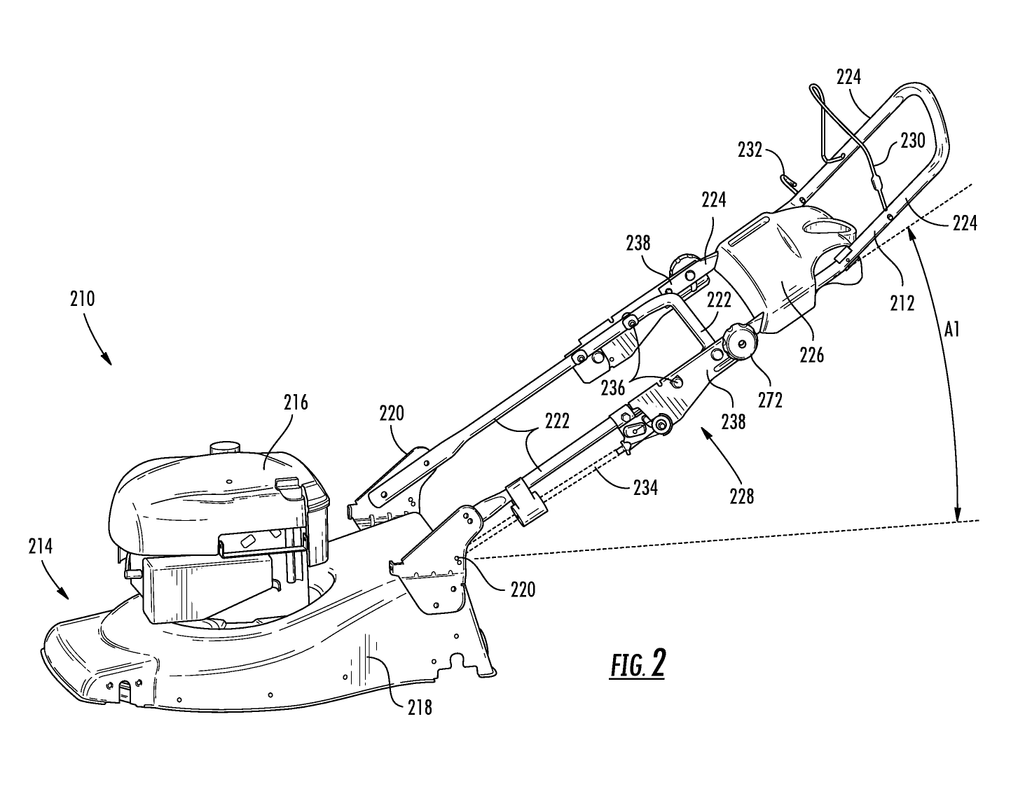

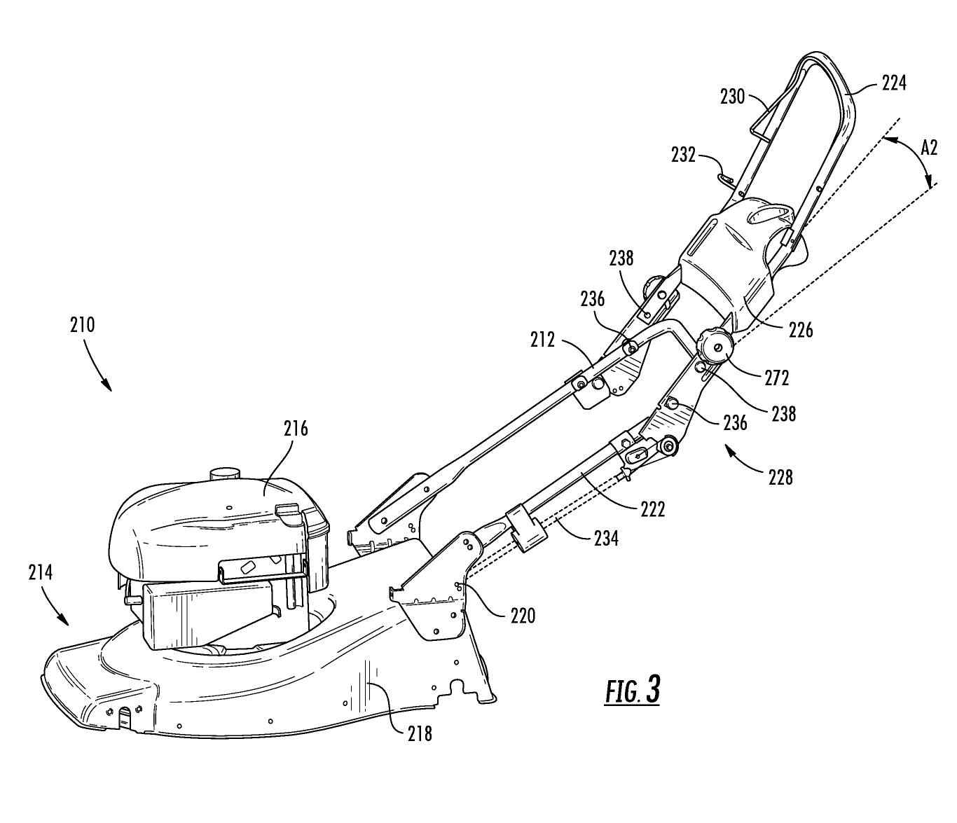

Referring now to FIGS. 2-3, self-propelled power equipment, shown as, but not limited to, lawn mower 210 includes a handle 212 and a body 214 having an engine 216 and a housing 218. The engine 216 is configured to drive a working implement that may be housed by the housing 218 (e.g., partially or substantially surrounding, shielding, enclosing, etc.). The handle 212 extends longitudinally rearward from the body 214, and includes a lower portion 222, an upper portion 224, and a control panel 226. According to an exemplary embodiment, the control panel 226 is fastened proximate to the middle of the upper portion 224, but in other embodiments, the control panel 226 is fastened to an end of the upper portion 224. In still other embodiments, no control panel is included. The handle 212 additionally includes a fail-safe lever 230, a rope guide 232 for a recoil starter pull cord, and a driving speed control assembly 228. The driving speed control assembly 228 is positioned substantially between the upper portion 224 and the lower portion 222 of the handle 212, and includes a linkage 234 coupled to the drivetrain of the lawn mower 210.

The lower portion 222 of the handle 212 is fastened to brackets 220 that are fastened to the housing 218. In some embodiments, the brackets 220 are designed to allow an angle A1 (see FIG. 2) of the handle 212 relative to the body 214 to be adjusted to a desired magnitude. For example, a taller user may unlock the lower portion 222 from the brackets 220, raise the handle 212 by rotating the handle 212 upward. Once the handle 212 is adjusted to the appropriate angle A1, the handle may be locked in place (e.g., with pins, bolts, latches, etc.). As such, the lower handle rigidly extends from the body 214 and does not rotate relative to the body 214 during normal operational use of the lawn mower 210. However, in other embodiments, the driving speed control assembly 228 may be coupled to either of the brackets 220 between the lower portion 222 of the handle 212 and the body 214. In such embodiments, the lower portion 222 may be designed to rotate relative to the body 214, even after the desired angle A1 is established.

Still referring to FIGS. 2-3, the upper portion 224 of the handle 212 is designed to be able to rotate relative to the body 214 of the lawn mower 210, even when the lower portion 222 is rigidly fixed to the body 214. According to an exemplary embodiment, the upper portion 224 rotates about a first pivot 236 (e.g., fulcrum, pivot, pin, etc.) positioned on the handle 212. In some embodiments, the first pivot 236 is positioned on the lower portion 222 proximate to or on the end of the lower portion 222 that is further from the body 214. Rotation of the upper portion 224 about the first pivot 236 is detected by the driving speed control assembly 228 and is relayed to the drivetrain of the lawn mower 210 to control the driving speed. Integration of driving speed control into movement the handle 212 may improve the ergonomics of the lawn mower 210, and the user need not lift a hand from the handle 212 in order to adjust the driving speed.

As the upper portion 224 of the handle 212 is rotated relative to the body 214 about the first pivot 236, the driving speed of the lawn mower 210 is related to (e.g., linearly or non-linearly proportional to) an angle A2 of the rotation of the upper portion 224 (see FIG. 3). In some embodiments, forward rotation of the upper portion 224 increases the driving speed and rearward rotation decreases the driving speed. When the upper portion 224 of the handle 212 is aligned with the lower portion 222, as shown in FIG. 2, the drivetrain may be disengaged such that the engine 216 is not used to drive wheels of the lawn mower 210. As such, rotational travel of the upper handle serves as a combination of both a drivetrain variable speed control and a drivetrain engagement control. According to an exemplary embodiment the angle A2 is limited by structure of the handle 212 (e.g., flange, hook, bracket, knob, slot, etc.) to an angle A2 that is less than ninety degrees of rotational travel, preferably less than thirty degrees.

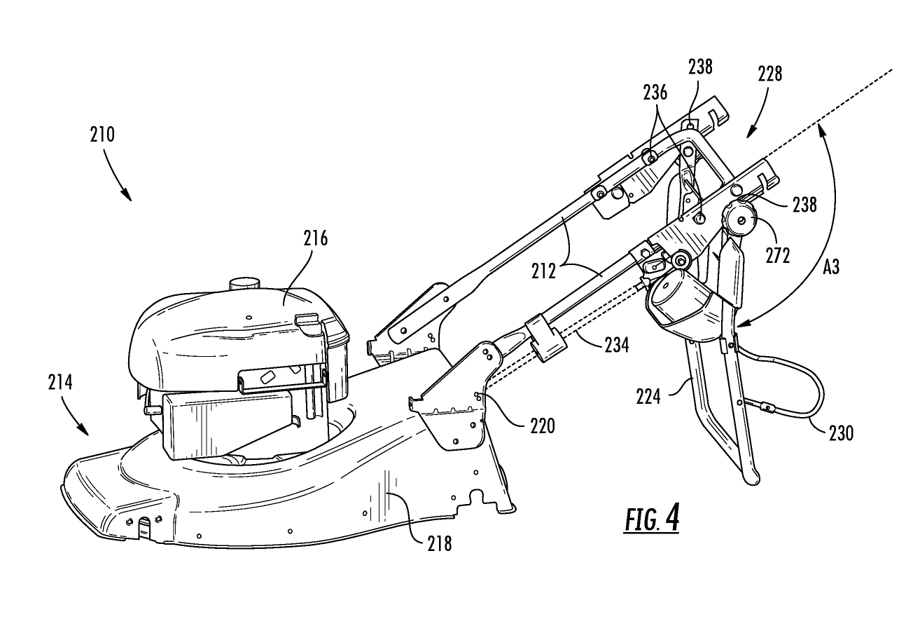

Referring now to FIGS. 2-4, according to an exemplary embodiment the upper portion 224 of the handle 212 additionally rotates about a second pivot 238 (e.g., releasable locking pivot, weld pin, peg, etc.) that is positioned on the handle 212. In some embodiments, the second pivot 238 is proximate to or on an end of the upper portion 224 of the handle 212, on the end that is closer to the body 214 of the lawn mower 210. Separation of the handle 212 into the upper and lower portions 224, 222 that are coupled together by the a lockable pivot, such as the second pivot 238, allows for the handle 212 to be folded substantially in half (see generally FIG. 4). In some embodiments, the brackets 220 (see FIG. 2-4) between the lower portion 222 of the handle 212 and the body 214 also include a releasable locking pivot, so that the lower portion 222 of the handle 212 may be folded over the body 214 of the lawn mower 210. As such, the handle 212 of the lawn mower 210 may be folded to fit into a compact storage space (i.e., the lawn mower 210 is adjusted to a storage configuration). According to an exemplary embodiment, folding the handle 212 reduces the longitudinal length of the lawn mower 210 by at least a foot, preferably two feet, and reduces the vertical height of the handle. Additionally, an angle A3 of the rearward rotation of the upper portion 224 of the handle 212 exceeds ninety degrees (downward rotation) when the lawn mower 210 is in the storage configuration (see FIG. 4).

In some alternative embodiments, the first and second pivots 236, 238 are combined in a single pivot. In such embodiments, the driving speed control assembly 228 may be disengaged when the handle 212 is folded for storage. However, in other embodiments, neither the upper portion 224 nor the lower portion 222 is designed to be folded into a storage configuration.

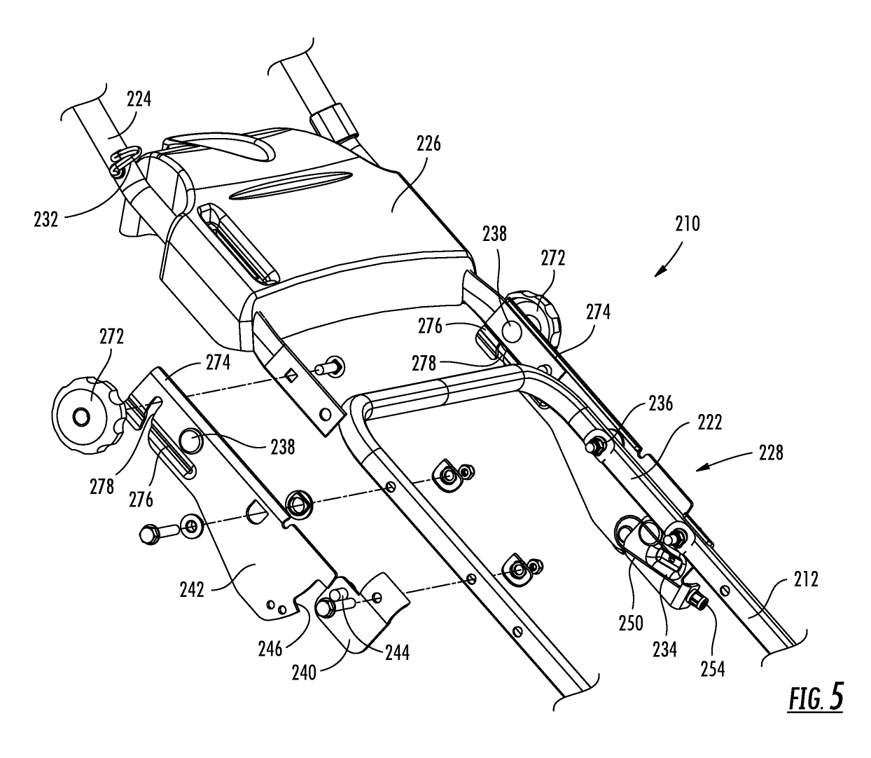

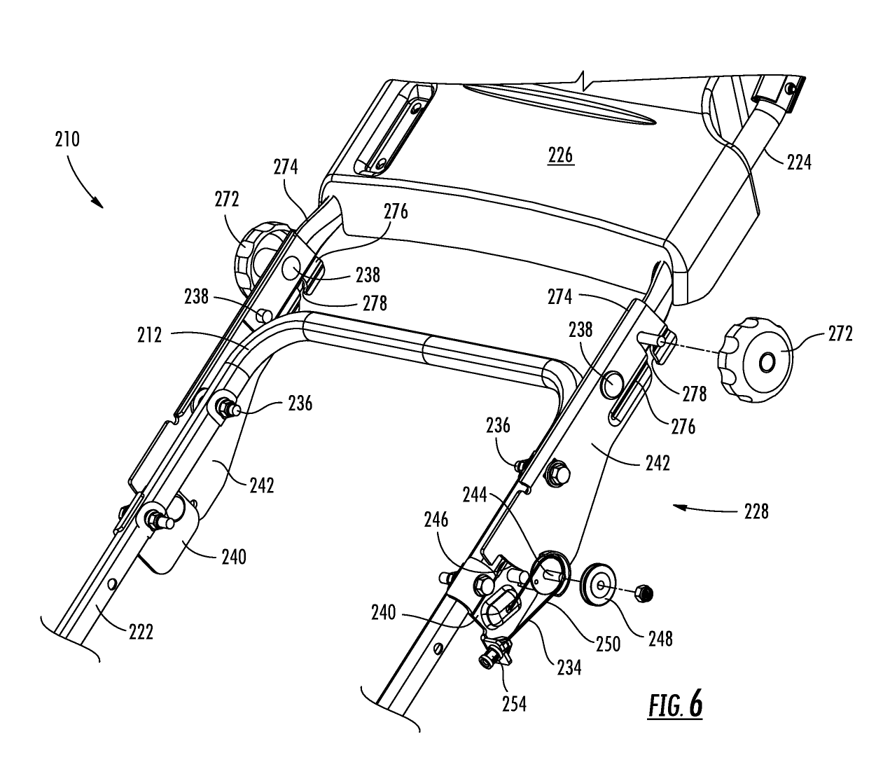

Referring now to FIGS. 5-6, the driving speed control assembly 228 of the lawn mower 210 includes a stop bracket 240, a pivot bracket 242, and a mechanism for scaling rotational travel of the pivot bracket 242 relative to the position of the stop bracket 240. The stop bracket 240 may be coupled to the lower portion 222 of the handle 212 and the pivot bracket 242 may be coupled to the upper portion 224 of the handle 212, such that rotation of the upper portion 224 of the handle 212 relative to the lower portion 222 and the body 214 of the lawn mower 210 is detected via movement of the pivot bracket 242 relative to the stop bracket 240. In some embodiments the stop bracket 240 is fixed to the handle 212, while in other embodiments the stop bracket is integrally formed with one of the portions 222, 224 of the handle 212. In other embodiments, the stop bracket 240 is coupled to the upper portion 224 of the handle, or is positioned between the lower portion 222 of the handle 212 and the body 214 of the lawn mower 210. Rotation of the pivot bracket 242 relative to the stop bracket 240 is limited by a stop pin 244 (e.g., weld pin, peg, etc.) that extends within a slot 246 of the pivot bracket 242 and extends from the stop bracket 240 (or from the lower portion 222 of the handle 212). Ends of the slot 246 contact the stop pin 244 at the extremes of the rotational path of the upper portion 224 of the handle 212 about the first pivot 236, through the slot 246.

The linkage 234 between the mechanism and the drivetrain of the power equipment (see generally FIG. 7) communicates the rotational travel of the upper portion 224 of the handle 212 to the drivetrain, which adjusts the driving speed of the lawn mower 210 accordingly. As shown in FIG. 6, the mechanism includes a pulley 248 coupled to the pivot bracket 242. In FIGS. 5-7, the linkage 234 is shown as a Bowden cable, which includes an inner wire 250 and a sheath 252 (see FIG. 7) within which the inner wire 250 may translate. Tension in the Bowden cable may be manually adjusted via an adjuster (e.g., barrel adjuster, adjustable spacer, etc.) positioned along the linkage. The sheath 252 of the Bowden cable is held in place by a retainer 254 (e.g., nut, barrel adjuster) coupled to the stop bracket 240, and the inner wire 250 of the Bowden cable extends though the retainer 254. The inner wire 250 of the Bowden cable is wrapped around the pulley 248 on the pivot bracket 242, and is fastened to the stop bracket 240. According to an exemplary embodiment, the inner wire 250 includes a die cast z-fitting on an end thereof, and the z-fitting is held by an anchor structure (e.g., aperture) in the stop bracket 240. As the upper portion 224 of the handle 212 is rotated, the inner wire 250 is pulled through the sheath 252. An opposite end of the Bowden cable is coupled to the drivetrain of the lawn mower 210 (see generally FIG. 7).

Referring now to FIG. 7, portions of the drivetrain of the lawn mower 210 are shown according to an exemplary embodiment. The engine 216 is mounted to the housing 218, and a power take-off 256 (e.g., crankshaft) of the engine 216 extends through an aperture in the housing 218 to drive a working implement, shown as a lawn mower blade 258. A sheave 260 is coupled to the power take-off 256 and a drive belt 262 extends between the sheave 260 and a second sheave 264 coupled to a transmission 266. Rotation of the power take-off 256 is transferred to the transmission 266 via the drive belt 262. The transmission 266 scales the rate of rotation of the second sheave 264, such as via a gear reduction, to rotate an output shaft of the transmission 266 that is coupled to the wheels 268, to drive the lawn mower 210.

The body of the transmission 266 is rotatable about the output shaft of the transmission 266. As the transmission 266 pivots or tilts about the output shaft toward or away from the crankshaft, tension may be adjusted in the drive belt 262. With a low amount of tension, the drive belt 262 slips between the sheaves 260, 264, and only a partial amount of the power take-off 256 rotation is transferred to the transmission 266 and wheels 268. With greater tension in the drive belt 262, an increased amount of power take-off 256 rotation is transferred to the transmission 266 and wheels 268, increasing the driving speed. The amount of tension in the drive belt 262 may be adjusted to a level such that effectively zero rotation of the power take-off 256 is transferred to the transmission 266 and the wheels 268, or to another level such that the full rate of rotation of the power take-off 256 is transferred (e.g., at the fastest driving speed).

Forward rotation of the upper portion 224 of the handle 212 (see FIGS. 2-3) is communicated to the drive train via the linkage 234 (e.g., Bowden cable) such that the linkage 234 either directly or indirectly adjusts the tension in the drive belt 262 between the sheaves 260, 264. According to an exemplary embodiment, forward rotation of the upper portion 224 of the handle 212 pulls the inner wire 250 of the Bowden cable, which in turn pulls a control spring 280 coupled to the transmission 266. Tension of the control spring 280 rotates the transmission 266 (and the second sheave 264) away from the sheave 260 on the power take-off 256, and increases tension in the drive belt 262, causing a greater amount of the rotation of the power take-off 256 to be transferred to the wheels 268, and thus increasing the driving speed of the lawn mower 210. Conversely, backward rotation of the upper portion 224 of the handle 212, reduces tension in the control spring 280, decreasing tension in the drive belt 262, which slows the driving speed. When the upper portion 224 of the handle 212 is aligned with the lower portion 222 of the handle 212 (i.e., angle A2 shown in FIG. 3 is approximately zero), tension in the drive belt 262 is insufficient to drive the wheels 268.

In some embodiments, a wire linkage is used that is not a Bowden cable. For example, a wire wrapped tightly around a series of sheaves may be used to communicate movement of the upper portion 224 of the handle 212 to the control spring 280. In other embodiments, the linkage is a set of interconnected mechanical rods that may be pushed or pulled by movement of the upper portion 224 of the handle 212, to transfer rotational travel of the handle, to increase or decrease tension in the drive belt 262. In at least one embodiment, an electric signal is communicated from the driving speed control assembly to an electric motor that is fully dedicated to the drivetrain, not used to simultaneously power a working implement.

In some alternate embodiments, the driving speed of the power equipment is controlled by the driving speed control assembly without adjusting tension in the drive belt 262. For example, in some embodiments, the driving speed control assembly may be coupled more directly to the engine 216, such as coupled to a throttle lever or a governor spring of the engine 216. Forward rotation of the upper portion 224 increases the engine speed, which in turn increases the driving speed.

Referring to the driving speed control assembly shown in FIGS. 5-7, the pulley 248 scales (e.g., amplifies, weights, adjusts, etc.) the rotational travel of the pivot bracket 242 by providing approximately a 2-to-1 mechanical advantage, scaling by half the travel distance and doubling the force of the pivot bracket 242. Accordingly, the pulley 248 serves as a simple mechanism for scaling communication between the upper portion 224 of the handle 212 and the drivetrain (see generally FIG. 7), which may help to prevent over-sensitivity of the driving speed control assembly, and may facilitate smooth changes in driving speed. In other embodiments, two or more pulleys may be used, increasing the mechanical advantage and scaling of the rotational travel. In still other embodiments, no pulley is used.

In some embodiments, the driving speed control assembly includes a mechanism other than a pulley, such as another simple machine, including a gear set of two or more gears, a belt system, a chain and sprocket arrangement, or other simple machines, which may be used to scale force and travel distance provided by rotation of the handle 212. In other embodiments, more elaborate mechanisms may be used, such as an electrical sensor that measures the rotation of the upper handle relative to the body, and relays the angle of rotation via wire to a solenoid or other actuator that adjusts the drivetrain. While such mechanisms are within the scope of the disclosure provided herein, a preferred embodiment uses a simpler mechanism with fewer parts, such as the pulley shown in FIGS. 5-6.

In still other embodiments, the mechanism of the driving speed control assembly does not scale the communication to the drivetrain provided by the linkage, or provide a mechanical advantage. In one such embodiment, a damper (e.g., dashpot) is provided to increase resistance to rotation of the upper handle. As such, the damper reduces sensitivity of the driving speed control assembly. In still other embodiments, a damper or other mechanism may be used in combination with other mechanisms described herein, as part of the driving speed control assembly.

Referring to FIGS. 5-7, knobs 270, 272 (e.g., adjustment knobs, handle knobs, etc.) may be coupled to the handle 212 to provide releasable locks for adjustment of the handle 212 to a desired orientation. The knob 270 shown in FIG. 7 may be used to lock the orientation of the lower portion 222 of the handle 212 relative to the body 214 of the lawn mower 210 (see also angle A1 as shown in FIG. 2). The knobs 272 shown in FIGS. 5-6 may be used to lock the upper portion 224 of the handle 212 to the lower portion 222, or to an intermediate bracket (e.g., brackets 240, 242). When the lawn mower 210 is to be stored, the knobs 270, 272 may be unlocked (e.g., loosened, released, etc.) and the handle 212 may be folded into a storage configuration, with the lower portion 222 of the handle 212 folded forward over the body 214 of the lawn mower 210 and the upper portion 224 folded backward over the lower portion 222 (cf. FIG. 4 with the upper portion 224 of the handle 212 folded, but not the lower portion 222). The structure of the pivot bracket 242 further includes a flange 274, a protrusion 276 (e.g., rib), and a slot 278 to guide and hold the upper portion 224 of the handle 212 when the handle 212 is in an operational configuration (see, e.g., FIGS. 2, 3, and 6), as opposed to the storage configuration (see, e.g., FIG. 4).

In an alternative embodiment, driving speed may be controlled by rotation of the lower portion 222 of the handle 212, or by rotation of a handle that is not separated into upper and lower portions. For example, the brackets 220 between the lower portion 222 and the body 214 may be rotatable, and the angle of rotation of the brackets 220 may be communicated to the drivetrain of the lawn mower 210. In such embodiments, mechanisms (e.g., gear reduction, pulley system, etc.) may be positioned between the lower portion 222 of the handle 212 and the drivetrain, such that a mechanical advantage is provided.

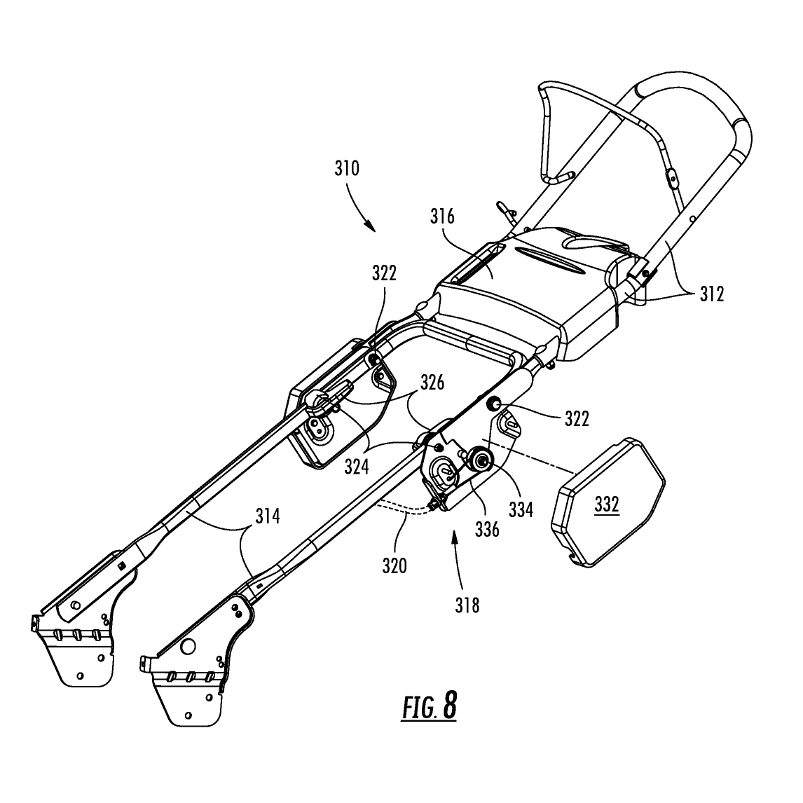

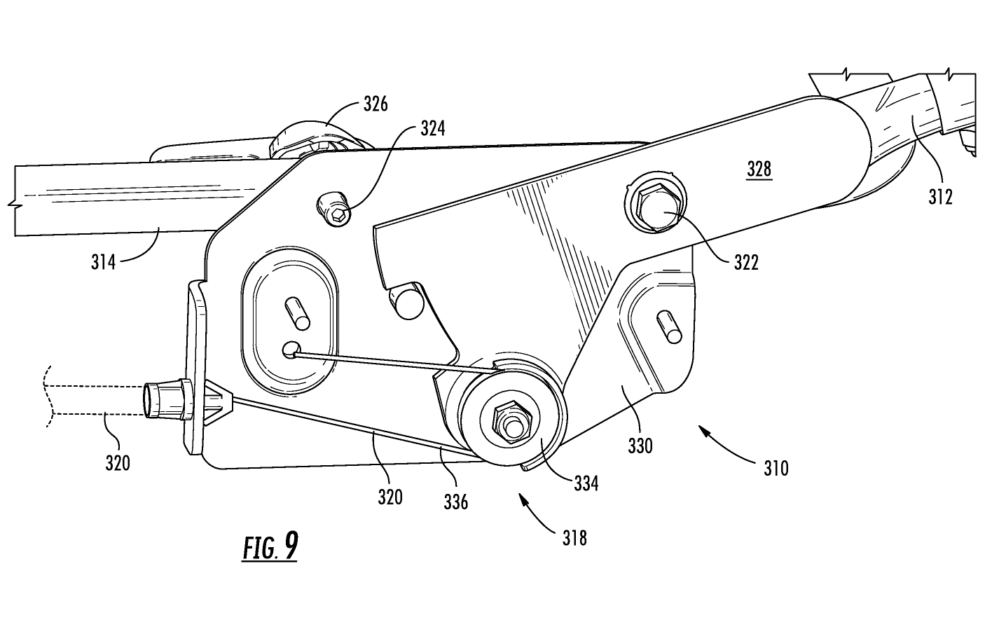

Referring now to FIGS. 8-9, a handle 310, according to another exemplary embodiment, includes an upper portion 312, a lower portion 314, a control panel 316, and a driving speed control assembly 318. The lower portion 314 is designed to be coupled to a body of power equipment (see, e.g., lawn mower 110), and the upper portion 312 is designed to be coupled to the lower portion 314. The driving speed control assembly 318 is positioned between the upper portion 312 and the lower portion 314, and is designed to communicate, via a linkage 320, a rotation angle of the upper portion 312 relative to the lower portion 314 (see, e.g., angle A2 as shown in FIG. 3). The linkage 320 communicates the rotation angle to a drivetrain of the power equipment (see generally FIG. 7).

The upper portion 312 of the handle 310 rotates about a pivot 322 to control the drivetrain when a pivot lock 324 is engaged. The upper portion 312 of the handle rotates further about pivot 322 when the pivot lock 324 is disengaged, allowing the power equipment to be converted to a storage configuration. The pivot lock 324 is releasably lockable, and includes a quick release knob 326. Rotating the quick release knob 326 by ninety degrees unlocks the pivot lock 324, allowing the upper portion 312 of the handle 310 to be folded relative to the lower portion 314. In other embodiments, other types of releaseable locks are used, such as the knobs 270, 272 as shown in FIGS. 2-7, a butterfly nut, a hex nut, a latch, or another releasable fastener.

The driving speed control assembly 318 of FIGS. 8-9 includes a pivot bracket 328, a stop bracket 330, a cover 332, and a mechanism for scaling the communication provided by the linkage 320 in response to movement of the pivot bracket 328 relative to the stop bracket 330. Rotation of the upper portion 312 of the handle 310 relative to the lower portion 314 about the pivot 322, moves a pulley 334 coupled to the pivot bracket 328. Rotational travel of the pulley 334 pulls a wire 336 that is part of the linkage 320. Pulling the wire 336 increases tension in a drive belt of the drivetrain, which increases the driving speed of the power equipment (see generally FIG. 7). The cover 332 covers components of the driving speed control assembly 318.

Rotation of the upper portion 312 of the handle 310 about the pivot 322, when the pivot lock 324 is disengaged, additionally rotates the brackets 328, 330 and cover 332 of the driving speed control assembly 318 upward. As such, the driving speed control assembly 318 protrudes when the power equipment is in a storage configuration, which may be a less preferred configuration than the storage configuration of the handle 212 of FIG. 4. Still other embodiments rely upon other arrangements of pivots for folding the power equipment into a storage configuration.

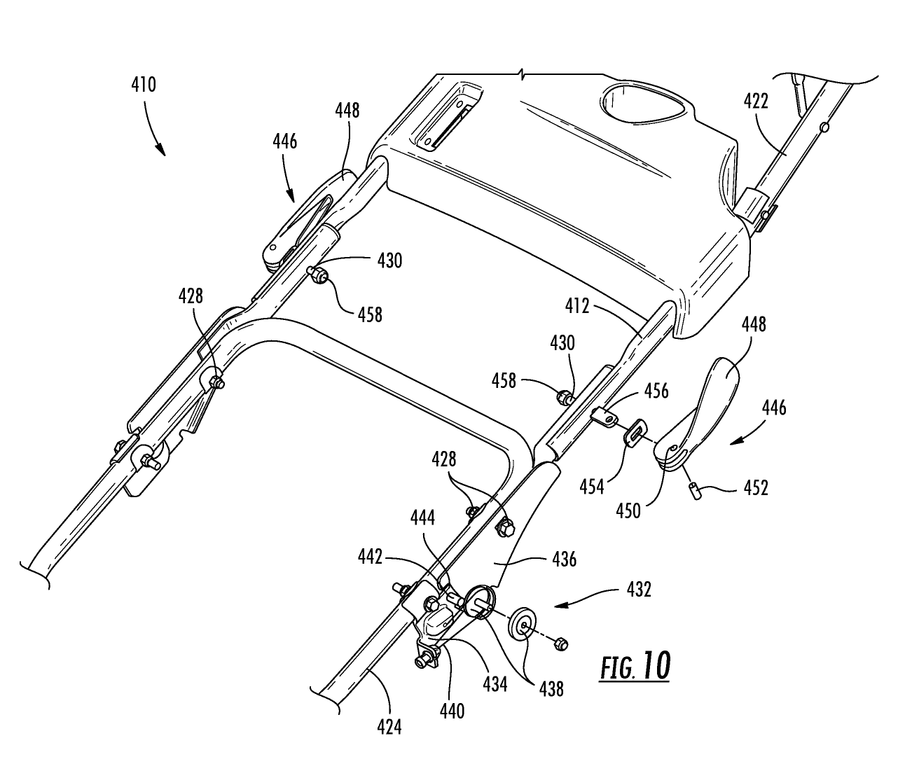

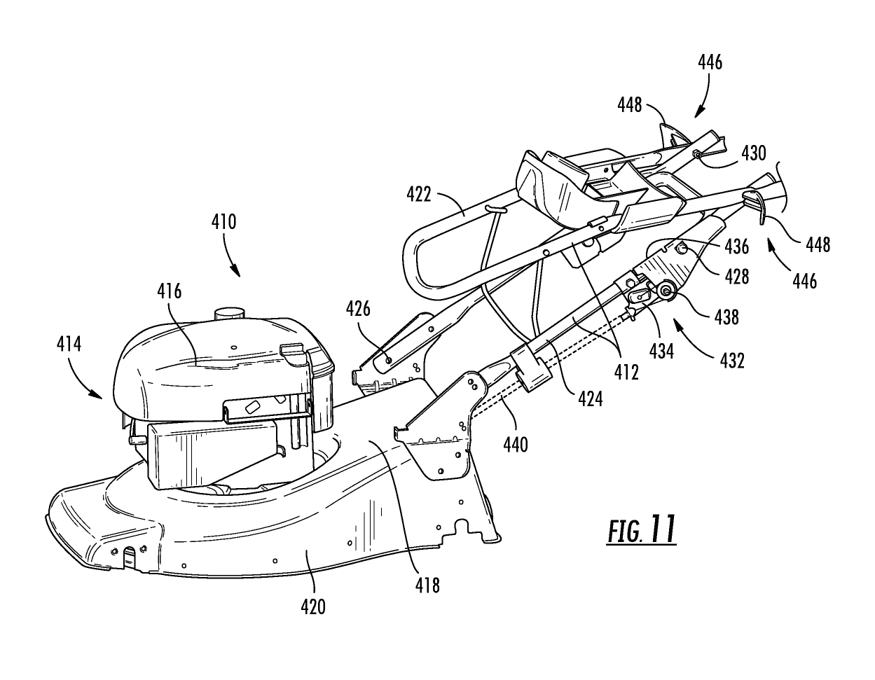

Referring to FIGS. 10-11 a lawn mower 410 (FIG. 11) includes a handle 412, a body 414, and a small combustion engine 416. On the body 414, the engine 416 is mounted to a mower deck 418, which includes a skirt 420 surrounding a mowing blade therein (see, e.g., blade 258 as shown in FIG. 7). The engine 416 drives the mowing blade and a drivetrain including wheels, treads, etc. (see, e.g., wheel 268 as shown in FIG. 7). According to an exemplary embodiment, the handle 412 includes an upper portion 422 and a lower portion 424. The upper and lower portions 422, 424 are rotatable relative to the body 414 about a first pivot 426, and the upper portion 422 of the handle 412 is rotatable relative to the lower portion 424 about a second pivot 428. In some embodiments, the handle 412 is foldable about a third pivot 430, such as to configure the lawn mower 410 for storage.

The handle 412 further includes a driving speed control assembly 432 positioned proximate to the second pivot 428. The driving speed control assembly 432 includes a first bracket 434, a second bracket 436 rotatable relative to the first bracket 434, a mechanism 438, and a linkage 440 coupled to the drivetrain. In some embodiments, the second bracket 436 is attached to the upper portion 422 of the handle 412 and the first bracket 434 is attached to the lower portion 242. Also in some embodiments, the amount of rotation of the first bracket 434 relative to the second bracket 436 is limited, such as by an extension 442 coupled to the first bracket 434 that slides in a slot 444 of the second bracket 436. Movement of the extension 442 is limited by sides of the slot 444.

During operation of the driving speed control assembly 432, as the upper portion 422 of the handle 412 is rotated forward relative to the lower portion 424, the linkage 440 is actuated, which communicates to the drivetrain (see generally FIG. 7). In some embodiments, the mechanism 438 amplifies movement of the linkage 440 by a factor (e.g., two, one-half, etc.). Also in some embodiments, the mechanism 438 amplifies force applied to the linkage 440. The communication of the linkage 440 to the drivetrain is used to control the driving speed of the lawn mower 410.

The upper portion 422 of the handle 412 is rotatable relative to the lower portion 424 of the handle 412 (i.e., foldable), such as to facilitate storage of the lawn mower 410 by temporarily reducing the length of the lawn mower 410. The handle 412 includes a cam lock assembly 446, which includes a lever 448 having an off-center hole 450 therein with a retainer pin 452 extending therethrough, a washer 454 (e.g., bearing surface, rectangular washer), a flattened pin 456 and nut 458 coupled to the retainer pin 452. Rotation of the lever 448 relative to the flattened pin 456 fastens or unfastens the upper portion 422 of the handle 412 relative to the lower portion 424 of the handle 412. When the cam lock assembly 446 is unlocked, the upper portion 422 of the handle 412 is configured to rotate either forward (e.g., upward and over) or downward.

Referring to FIG. 10, the lever 448 of the cam lock assembly 446 is rotated to a locked position, fastening the upper portion 422 of the handle 412 relative to the lower portion 424, such that the handle 412 is in an operational configuration. Referring now to FIG. 11, the lever 448 is rotated to an unlocked position, unfastening the upper portion 422 of the handle 412, shown in a storage configuration. In some embodiments, the handle 412 may additionally be rotated about the first pivot 426, where the lower portion 424 of the handle 412 rotates forward, over the body 414 of the lawn mower 410, to further narrow the length of the lawn mower 410 when in a storage configuration.

While rotation of the handles 212, 310, 412 (e.g. upper portion) may be used by the driving speed control assemblies 228, 318, 432 to control driving speed of power equipment, in other embodiments, rotation of the handles 212, 310, 412 may be used to control other functions or characteristics of power equipment. In at least one embodiment, rotation of the handle 212, 310, 412 increases or decreases a speed of a working implement, such as an auger, a blade, a saw, etc. In other embodiments, rotation of the handle 212, 310, 412 throttles or idles a prime mover coupled to the power equipment.

The construction and arrangements of the driving speed control for power equipment, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. Power equipment configured to be operated by a user walking behind the power equipment, comprising:
an engine driving a working implement;
a body;
a drivetrain coupling the engine to at least one wheel configured to drive the power equipment;
a handle extending from the body, wherein at least a portion of the handle is configured to rotate relative to the body;
a linkage, wherein rotation of the at least a portion of the handle relative to the body is communicated to the drivetrain via the linkage and controls a driving speed of the power equipment; and
a mechanism configured to provide a mechanical advantage between rotation of the handle and operation of the linkage.

2. The power equipment of claim 1, wherein the mechanism comprises at least one of a pulley, a gear, a chain, and a belt.

3. The power equipment of claim 2, wherein the linkage comprises a Bowden cable.

4. The power equipment of claim 3, wherein the mechanism comprises a pulley about which the Bowden cable is wrapped, the pulley generally providing a 2-to-1 mechanical advantage.

5. The power equipment of claim 4, wherein the handle comprises a lower portion coupled to an upper portion by a pivot.

6. The power equipment of claim 5, wherein the upper portion and the lower portion are approximately the same length, such that the pivot is positioned substantially in the middle of the handle.

7. The power equipment of claim 6, wherein the pivot is a first pivot, and wherein the power equipment further comprises a second pivot substantially between the upper portion and the lower portion, the second pivot configured to allow the upper portion to be rotated into a storage configuration, whereby the longitudinal length of the power equipment is reduced.

8. The power equipment of claim 7, wherein the upper portion and the lower portion are approximately the same length, and wherein the second pivot is positioned proximate to the first pivot such that both pivots are positioned substantially in the middle of the handle.

9. The power equipment of claim 8, wherein the working implement is at least one of a lawn mower blade and an auger.

10. Power equipment configured to be operated by a user walking behind the power equipment, comprising:
a combustion engine driving a working implement;
a body;
a drivetrain coupling the engine to at least one wheel;
a handle extending from the body, the handle comprising:
an upper portion;
a lower portion;
a first pivot, wherein at least one of the portions of the handle is configured to rotate relative to the body about the first pivot; and
a second pivot couples the upper portion and the lower portion, and is configured to allow the upper portion to be rotated into a storage configuration, such that the longitudinal length of the power equipment is reduced; and
a linkage, wherein rotation of the at least one of the portions of the handle relative to the body is communicated to the drivetrain via the linkage and controls a driving speed of the power equipment.

11. The power equipment of claim 10, wherein the longitudinal length of the power equipment is reduced by at least a foot when the upper portion of the handle is rotated into the storage configuration.

12. The power equipment of claim 11, wherein forward rotation of the upper portion of the handle about the first pivot increases the driving speed of the power equipment, and rearward rotation of the upper portion of the handle about the first pivot decreases the driving speed of the power equipment.

13. The power equipment of claim 12, wherein rotation of the upper portion of the handle about the first pivot is limited to an angle of rotation that is less than ninety degrees.

14. The power equipment of claim 12, wherein rotation of the upper portion of the handle about the first pivot is limited to an angle of rotation that is less than thirty degrees.

15. The power equipment of claim 14, wherein rotation of the upper portion of the handle about the second pivot to the storage configuration includes a downward rotation that is greater than ninety degrees.

16. The power equipment of claim 15, wherein the power equipment is a lawn mower.

17. A self-propelled, walk-behind, rotary lawn mower, comprising:
a combustion engine driving a lawn mower blade;
a body;
a drivetrain coupling the engine to at least one wheel;
a handle extending rearward from the body, the handle comprising:
an upper portion;
a lower portion;
a first pivot, wherein at least one of the portions of the handle is configured to rotate relative to the body about the first pivot; and
a second pivot coupling the upper portion and the lower portion, and configured to allow the upper portion to be rotated into a storage configuration, such that the longitudinal length of the lawn mower is reduced;
a linkage, wherein rotation of the at least one of the portions of the handle about the first pivot is communicated to the drivetrain via the linkage and controls a driving speed of the at least one wheel; and
a mechanism comprising at least one of a pulley, a gear, a belt, and a chain, the mechanism configured to provide a mechanical advantage between rotation of the at least one of the portions of the handle about the first pivot and operation of the linkage on the drivetrain.

18. The lawn mower of claim 17, wherein forward rotation of the upper portion of the handle about the first pivot increases the driving speed of the lawn mower, and rearward rotation of the upper portion of the handle about the first pivot decreases the driving speed of the lawn mower, and wherein rotation of the upper portion of the handle about the first pivot is limited to an angle of rotation that is less than thirty degrees.

19. The lawn mower of claim 18, wherein the mechanism comprises the pulley and the linkage comprises a Bowden cable.

20. The lawn mower of claim 19, wherein the longitudinal length of the lawn mower is reduced by at least a foot when the upper portion of the handle is rotated into the storage configuration.
